(19) United States
(12) Patent Application Publication
(10) Pub. No.: US 2006/0170759 A1
(43) Pub. Date: Aug. 3, 2006

(54) Methods and apparatus for optimizing digital asset distribution

(75) Inventors: Stefan Roever, Los Altos Hills, CA (US); Kevin Collins, Cupertino, CA (US); Alex F. Clark, San Jose, CA (US); Nathan Chan, Sunnyvale, CA (US)

Correspondence Address: BEYER WEAVER & THOMAS LLP, P.O. BOX 70250, OAKLAND, CA, 94612-0250, US

(73) Assignee: NAVIO SYSTEMS INC.

(21) Appl. No.: 11/146,399

(22) Filed: Jun. 3, 2005

Related U.S. Application Data
(60) Provisional application No. 60/649,928, filed on Feb. 3, 2005.

(51) Int. Cl. H04N 7/14

(52) U.S. Cl. 348/14.03

(57) ABSTRACT

Methods and apparatus are described for the distribution of digital assets in title-enabled systems. More specifically, these methods and apparatus employ title objects, i.e., unique instances of digital bearer instruments, to optimize the distribution of digital assets.

### RELATED APPLICATION DATA

This application claims priority under 35 U.S.C. 119(e) to U.S. Provisional Patent Application No. 60/649,928 filed Feb. 3, 2005 (Attorney Docket No. NAV1P006P), the entire disclosure of which is incorporated herein by reference for all purposes.

### BACKGROUND OF THE INVENTION

The Internet has become an efficient mechanism for globally distributing digital content, such as documents, pictures, music, and other types of digital content. Information can now be transmitted directly and instantly across the Internet from the content owner to the content buyer, without having to first convert it into physical form, such as paper documents, compact disks, photographs, etc.

However, the advantage of easy digital communication has also allowed digital content to be easily pirated by just about anyone with a computer and Internet access. The combination of high-speed broadband Internet access, digital content compression software (which reduces the size of digital content files), peer-to-peer file trading networks (which allows users to post content files), and lack of a viable digital rights standard, has caused the content owners to lose control of their content. Consequently, content owners are experiencing a loss of potential revenue.

The lack of a standardized and transparent digital rights management system, however, is preventing a commercially viable solution from emerging. In order for such a system to be commercially viable, the system should be secure both from the user's and the content owner's standpoint, universal so that electronic device manufactures are encouraged to engineer it into their products, and transparent so that users are not required to change their behavior.

Existing systems that attempt to provide confidence between buyers include escrow agreements, third party confirmations, third party appraisals and other similar techniques. These systems are slow and complex, and they do not provide the content user with sufficient confidence that the buyers and sellers are not illegally replicating the content or otherwise attempting to sell pirated copies of works.

In addition to the pirating aspects associated with sharing digital content, users are burdened with less than ideal methods for legally sharing digital content. These cumbersome methods include transferring entire files to other users via electronic mail, instant messenger, peer-to-peer and other applications, or sharing hyperlinks via electronic mail, instant messenger, and other applications. These methods can be viewed as counter productive, anti-social and even bothersome to the users that receive or attempt to share the content. Sharing of entire digital content such as music via electronic mail is a drain on resources and inefficient to the electronic mail servers, the network, and the receiving users. Sharing of hyperlinks can lead to broken links, complex URL (Universal Resource Locator) strings, and restrictions on the type of content that can be shared (i.e. linked to). Compatibility problems are widespread and create frustration when sharing digital content of a specific media type.

What is needed are advanced techniques for controlling the trading of digital rights so that the buyers are assured of an authentic copy, “fair use” is preserved for the copy, and content owners are fairly compensated. In addition, advanced techniques are employed to provide an easy, friendly, efficient, and adaptable method for users to share digital content.

What are needed are methods and apparatus for optimizing digital asset distribution.

### SUMMARY OF THE INVENTION

According to the present invention, a variety of techniques for optimizing digital asset distribution using title objects is provided. A title object is a unique instance of a digital bearer instrument representing at least one right which may be redeemed by presentation of the title object.

According to a specific embodiment, computer-implemented methods and apparatus are provided for interacting with a title-enabled system which is operable to conduct transactions using title objects. An asynchronous message is received from a first device with the title-enabled system. The asynchronous message instructs the title-enabled system to conduct a first transaction involving transfer of at least one of title objects. The first device is not configured to conduct the first transaction. The asynchronous message is interpreted and the first transaction is conducted on behalf of the first device.

According to another specific embodiment, computer-implemented methods and apparatus are provided for guaranteed delivery of digital content using title objects. A first title object is transmitted to a recipient in response to selection of the digital content and the recipient by a sender. The first title object defines a proof-of-delivery mechanism. In response to presentation of the first title object by the recipient, completion of the proof-of-delivery mechanism by the recipient is facilitated. Access to the digital content by the recipient is then facilitated in response to completion of the proof-of-delivery mechanism.

According to yet another specific embodiment, computer-implemented methods and apparatus are provided for delivery of digital content using title objects. A first title object is transmitted to a recipient. The first title object represents a right to receive the digital content upon completion of a specified action. In response to presentation of the first title object by the recipient, completion of the specified action by the recipient is facilitated. A second title object is transmitted to the recipient in response to completion of the specified action. The second title object represents a right to access the digital content. Access to the digital content by the recipient is then facilitated in response to presentation of the second title object.

According to still another specific embodiment, computer-implemented methods and apparatus are provided for facilitating interaction with a game which includes a plurality of sequential steps using title objects. A first title object is transmitted to a player. The first title object represents a right to participate in a first step of the game. Participation of the player in the first step of the game is facilitated in response to presentation of the first title object. A second title object is transmitted to the player in response to completion of the first step of the game. The second title object represents a right to participate in a second step of the game. Participation of the player in the second step of the game is facilitated in response to presentation of the second title object.

According to a further specific embodiment, computer-implemented methods and apparatus are provided for facilitating voting using title objects. A first title object is provided to a voter. The first title object represents a right of the voter to cast a vote. Casting of the vote by the voter is facilitated in response to presentation of the first title object.

According to still a further specific embodiment, computer-implemented methods and apparatus are provided for tracking a transaction involving title objects. The transaction is facilitated with a title-enabled system by facilitating transfer of the title objects between entities involved in the transaction. Selected ones of the title objects represent rights of the title-enabled system to capture tracking information for corresponding aspects of the transaction. In conjunction with facilitating transfer of each of the selected title objects, the rights to capture the tracking information are invoked.

According to yet another specific embodiment, computer-implemented methods and apparatus are provided for providing access to digital content using title objects. Each title object is a unique instance of a digital bearer instrument representing at least one right which may be redeemed by presentation of the title object. A digital content file is transmitted to a user. In response to selection of the digital content file by the user, a try option, a buy option, and an earn option are presented to the user. The try option enables the user to preview at least a portion of the digital content file. The buy option enables the user to purchase the digital content file. The earn option enables the user to purchase the digital content file and earn value for providing the digital content file to other users. In response to selection of one of the try, buy, and earn options by the user, the selected option is facilitated using the title objects.

A further understanding of the nature and advantages of the present invention may be realized by reference to the remaining portions of the specification and the drawings.

### BRIEF DESCRIPTION OF THE DRAWINGS

FIG. 1 is a block diagram of an exemplary system for distributing digital assets according to a specific embodiment of the invention.

FIG. 2 is a flowchart illustrating an exemplary process relating to an electronic content delivery system according to a specific embodiment of the invention.

FIG. 3 is a flowchart illustrating an exemplary process for implementing an interactive and dynamic game according to a specific embodiment of the invention.

FIG. 4 is a block diagram of an exemplary web content payment and services title transaction system according to a specific embodiment of the invention.

FIG. 5 is a diagram of an exemplary title data structure according to a specific embodiment of the invention.

FIG. 6 is a diagram of an exemplary title data structure according to another specific embodiment of the invention.

FIG. 7 is a block diagram of an exemplary wireless locker system according to a specific embodiment of the invention.

FIG. 8 shows a simplified user interface to a wireless locker according to a specific embodiment of the invention.

FIG. 9 shows a simplified messaging-based interface for a wireless locker according to another embodiment of the invention.

FIG. 10 is a flowchart illustrating an exemplary process for purchasing wireless content using a title-enabled wireless locker according to a specific embodiment of the invention.

FIG. 11 is a flowchart illustrating an exemplary process for downloading content that a user has already purchased according to a specific embodiment of the invention.

FIG. 12 is a flowchart illustrating an exemplary process for implementing a wireless locker according to a specific embodiment of the invention.

FIG. 13 is a simplified diagram of a wireless photo album according to a specific embodiment of the invention.

FIG. 14 is a flowchart illustrating an exemplary process for implementing a title-based MMS photo album according to a specific embodiment of the invention.

FIG. 15 is a block diagram of an exemplary media transaction and distribution system according to a specific embodiment of the invention.

FIG. 16 is a diagram of an exemplary title data structure for use in a media distribution system according to a specific embodiment of the invention.

FIG. 17 is a flowchart illustrating an exemplary reseller process according to a specific embodiment of the invention.

FIG. 18 is a diagram illustrating creation of a fan site according to a specific embodiment of the invention.

FIG. 19 is a simplified diagram illustrating the mapping of a title to a physical item according to a specific embodiment of the invention.

FIG. 20 is a block diagram of an exemplary title-based voting system according to a specific embodiment of the invention.

FIG. 21 is a flowchart illustrating an exemplary title-enabled voting process according to a specific embodiment of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

The invention is directed to the facilitation of digital asset distribution through the creation, ownership, exchange, management of title objects (also referred to herein simply as titles). A title object is a self-authenticating, digital bearer instrument which expresses rights or permissions to which the holder of the object is entitled. A title object may include a number of elements and attributes including embedded digital content, ownership attributes, copy permissions, and others as described herein.

A title can represent the rights to a single piece of digital content or a single resource, or it can represent the rights to a multitude of digital content and resources and in a variety of formats. The digital content rights, such as the ability to exchange or copy, are typically determined by the content publisher. Furthermore, a title can also represent the rights to another title or multitude of titles, which in turn express rights to digital content or resources.

A title object generally includes title data which describe and/or define the rights associated with the title object, and a stub object which serves as a mechanism for validating the title object. Title data may include a high level description of what the title object relates to. For example, if a title object enables access to a song embodied in a digital content file, the description might identify the song title, the artist, and the file format. The title data also describe each of the one or more rights to which the possessor of the title object is entitled. Staying with the example, of the digital content file, presentation of the title object might enable the presenter to listen to the song embodied in the digital content file, to share the digital content file with another user, to copy the digital content file, etc.

The title data describing each right may further include an identifier or pointer which identifies an address, a resource, computer code, etc., with which the associated right may be redeemed. So, for example, a right may be redeemed by presentation of the title object to an address to which the title data point. This address, resource, code, etc., may be remotely located or stored, or may actually be embedded in the title object itself.

According to specific implementations, the stub object is a mechanism which tracks a current state of the title object which is compared with an externally stored state (e.g., in a state server) to determine the title object's validity. Each time the title object is “touched” by a process (e.g., when it is used in a transaction), the state represented by the stub object is compared to the externally stored state. If they are the same, the title object is determined to be valid and the transaction is allowed to proceed. The state of the title object (as represented by the stub object) and the externally stored state are then updated to a new state. This ensures, for example, that even though copies of a title object are made, only one of the copies may be used, i.e., all other copies are invalidated when one of the copies is used. This mechanism also eliminates any requirement for tracking ownership of title objects (although this may be done in specific implementations).

In general, embodiments of the present invention may be implemented using title objects and title-enabled systems as described in International Publication No. WO 03/098398 A2 (International Application No. PCT/US03/15614; Attorney Docket No. NAV1P004WO), the entire disclosure of which is incorporated herein by reference for all purposes.

Users can initiate a variety of exchanges with each other depending on the type of title and the rules associated with that title. These exchanges can take the form of trades or transfers. In the case of trades, offers can be reviewed, and then subsequently accepted, canceled, or a counter-offer can be presented. The counter-offer process can continue until satisfaction, or until trade is canceled.

In order to help protect the integrity of the trade, a chained hash cryptographic technique is used to implement each title object's stub to guarantee that only a single instance of the title is in circulation at any one point in time. The title management and publisher structure may perform verification on the chained hash to ensure its integrity. The chained hash technique may be implemented in such a way as to provide benefits typically associated with one-time password and digital cash systems. However this implementation may be modified to provide a high degree of integrity around the use of titles within the ecosystem.

The chained hash technique can be combined with additional controls that work in conjunction with the security classification element to provide varying degrees of security for the title and the digital content referred to by the title. These additional controls may include cryptographic key-splitting techniques as well as multi-user and multi-factor authentication. Security class is an element that resides in the title to convey the level of security appropriate for this title. Security class is set by the publisher based on the publisher's requirements and rules. Security class can be used within the ecosystem to determine appropriate handling of the title. For example, a title with a high-security rating of 5 can force strong authentication of the user as well as strong encryption of the digital content associated with the title. As an example, a multi-user authentication requirement can be used for parental controls, whereby a guardian must also provide authentication (and acceptance) on the purchase and use of a title where a minor is involved.

The content rating system can be used by publishers to determine appropriate ratings for their content, and these ratings can be enforced by title management and resolver apparatus to ensure guardian approval. Content rating is an element within the content element to convey a rating regarding the suitability of the content. The rating system is dependent on the type of content and the regulatory factors involved (e.g. music, video, movie, etc.).

The exchange structure, specification, and rules provide the ability for the title publisher and/or the title owner to determine the exchange capabilities of subsequent owners of the title. For example, a title publisher could limit a title owner to only one trade, or even to deny trades but allow transfers. A title owner may transfer the title to another person for a limited period of time and deny that person any ability to trade or transfer. This ability to set limitations may operate in conjunction with the rules structure.

A trust structure is also implemented to provide users with a simple ability to validate the digital content they receive. The trust structure may convey that the digital content was (if applicable) rightfully issued by the content publisher. Content publishers are not bound to use the trust structure for the titles they issue but in doing so can provide assurances to the buyer.

The invention is described with reference to specific apparatus and embodiments. Those skilled in the art may recognize that the description is for illustration and to provide the best mode of practicing the invention. For example, references are made to computer servers and clients, but in a peer-to-peer network, any computer is capable of acting in either role. Likewise, reference is made to Internet protocol while any substantially comparable data transmission protocol can be used.

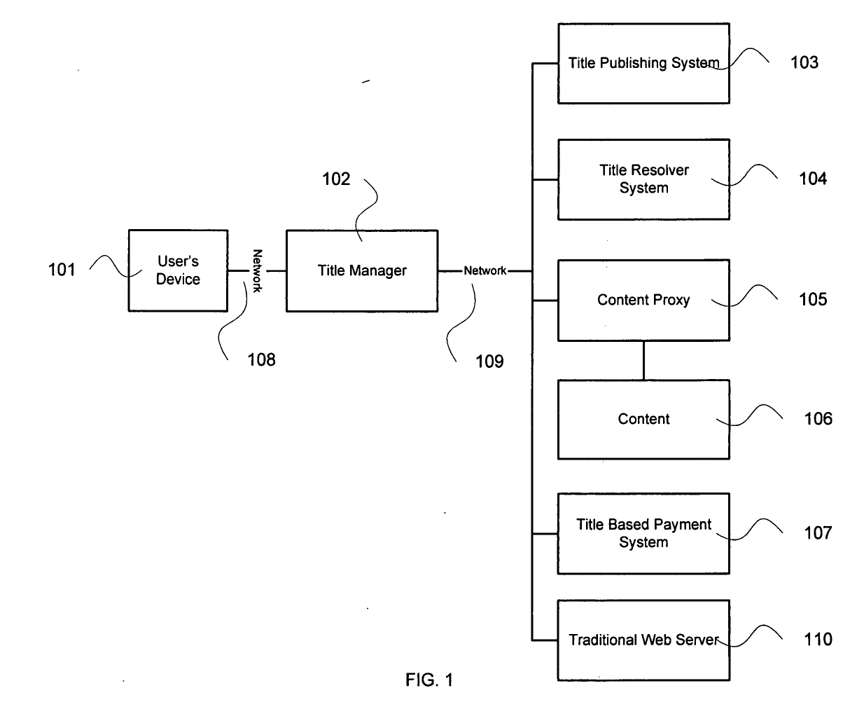

Referring now to FIG. 1, an example of a system that manages the distribution and access to digital asset architecture is shown, according to one embodiment of the invention. Although the diagram shows separate components that maybe operated on separate computing devices, in another embodiment these components can be operated on the same device. In one embodiment, the functionality of title manager 102 can be operated directly on consumer device 101 as a complete application. Likewise the functionality of the title redemption system 104 may exist on the title publishing system 103. Also the term network refers to any mechanism that allows the transfer of data between computing devices. Examples of different approaches to generating, storing, managing, and transferring title objects which are within the scope of the invention are described in International Publication No. WO 03/098398 A2 incorporated herein by reference above.

According to various embodiments of the invention, a delivery mechanism may be implemented by which digital content may be reliably delivered to one or more recipients. According to one such implementation, a user can instruct a title manager interface to send a particular item of digital content to one or more recipients. As will be discussed below, the instruction may be embedded in any of a wide variety of message types and may be delivered from a platform which is not title-enabled. Alternatively, the instruction may result from the manipulation of title objects by the user in a title management interface. In response to the instruction, the title manager either generates or retrieves one or more titles representing the right to access the content, and transmits the title(s) to the intended recipient(s). The recipient(s) may then redeem the content as possessors of the title.

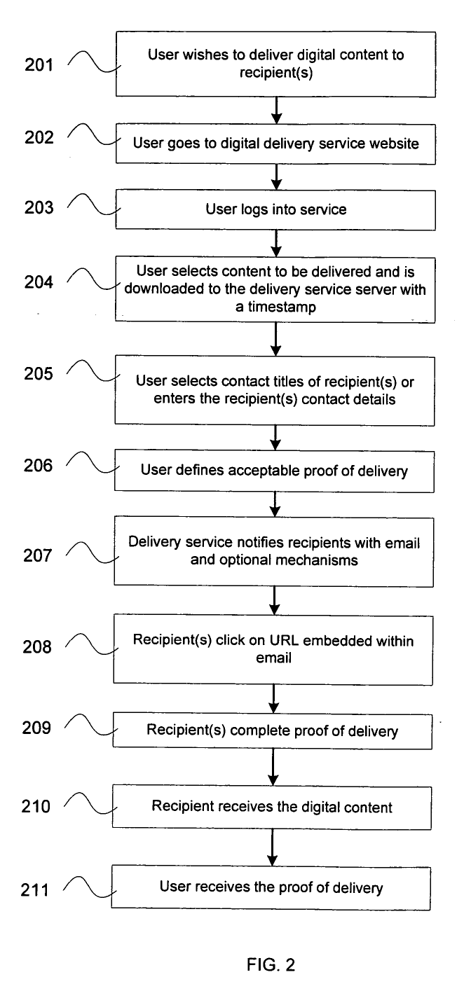

Referring now to FIG. 2, a simplified process of using titles to implement an electronic content delivery system for the delivery of important electronic is shown, according to one embodiment. Sending digital content by mechanisms such as email or FTP may be difficult for many users.

For example, email systems commonly impose limits on the size of the message and do not guarantee message delivery. It's not readily convenient to use real-time communication methods (e.g., phone, etc.) to confirm message delivery or to arrange retransmission, when the parties in reside in widely disparate time zones.

Distributing content through FTP, or file transfer protocol, also presents problems. Since FTP sites are often difficult to set up, and may also present security risks when exposed on public networks, corporations normally have a policy of not providing such services to users. Furthermore, if the FTP content is encrypted (i.e., password protected files, etc.), password or decryption key distribution is problematic.

The user wishes to send important piece of electronic content to a number of recipient(s) 201. The user goes to the digital delivery service which could be a third party hosted solution, or a service provided by the user's company 202. The user logs into the service depending on the embodiment of the service the login process could be title based, user name and password based, or payment based 203. The user selects the content to be delivered which is downloaded to the delivery system and the download time is time stamped. Optionally encryption protocols that require no user intervention such as SSL can be used to provide security. Compression techniques can also be optionally defined in order to provide a more efficient transfer of the data.

The user then defines the recipient list and contact using the most appropriate mechanism for the user 205. Embodiments of defining the recipient list include using title enabled contacts (as described in International Publication No. WO 03/098398 A2 incorporated herein by reference above), entering the recipients details manually, or using other mechanisms such as vcards. In defining the recipient list the user can define multiple contact points for example email address, IM address, SMS/MMS number, mobile phone number, and phone number. The user can also enter a message that may be individualized for each recipient. The user then defines the mechanism that the recipients must use to acknowledge receipt of the electronic content, and which will provide proof of delivery 206. The delivery service will the notify the recipients with an email that will contain a title (e.g., generated by a Title Publisher) that will refer to the location of the content 207. The delivery service communicates with the Title Publisher to generate the appropriate title that references the content and expresses the appropriate rights for each of the recipients. Depending upon the mechanisms defined by the user there will be optional reminder and notification options for the recipients. These notification and reminder mechanism include sending messages to the recipient's phone, instant messaging accounts, sending to alternative email accounts, and resending the messages if the electronic content is not downloaded within a certain time.

When the recipient(s) wish to receive the content they will click on the title 208, the title will take the user to the proof of delivery page were the recipient will acknowledge proof of delivery by the mechanism defined by the user or the service provider 209. Possible embodiments of these mechanisms include the recipient has to provide a title that he has received earlier, fill in contact details such as their mobile phone number, electronic signatures and clicking on a button to acknowledge receipt. Once of the proof of delivery has been completed the electronic content will be downloaded to the recipient 210.

In another embodiment, the title first received by the recipient is a right-to-receive title that requires additional information from the recipient. As part of accepting this right-to-receive title, the user provides the information such as mobile number or additional authenticating material. The information is then verified and the right-to-receive title is used by the Title Publisher to automatically generate a new title for the recipient. This new title is a receipt and confirmation, plus the expression of various rights to download the content and possibly share the content. The right-to-receive title grants the Title Publisher the right to generate the receipt title and provides instructions on the rights that the receipt title must contain and who it must be issued to.

The download mechanism can optionally include a non repudiation mechanism, security mechanisms such as HTTPS, and compression technology. The user will receive proof delivery to the recipients in a title format in other embodiments it may be another format 211. If the recipient wishes to download the content again or if they wish for another person to download the content, then depending on the rights assigned to the title, these actions can be carried out. The user who sent the content has the ability to limit the sharing and number of downloads. The limitations are expressed in the rights contained within the title.

In another embodiment, the user may specify that if the electronic content has not been delivered by a certain time, an alert could be generated using appropriate mechanisms such as email, SMS, and instant messaging. In one embodiment, this is implemented as part of a workflow engine that can also be title enabled. The workflow engine can process system rights expressed by the title to notify recipients, notify the owner, or perform other workflow related tasks.

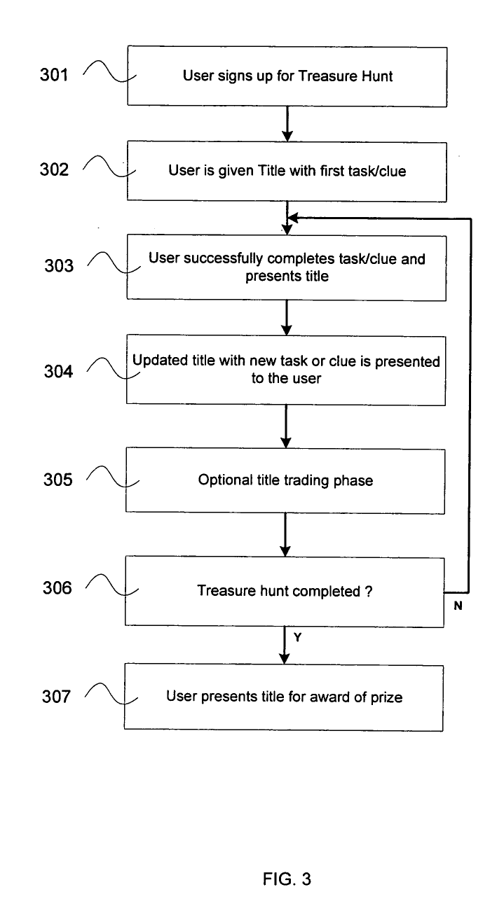

Referring now to FIG. 3, a simplified process of using titles to implement an interactive and dynamic game such as a treasure hunt is shown. A digital treasure hunt is an electronic equivalent of a physical treasure hunt were people go from location to location based upon clues that they find at that location, at the end the winner is the first person or group of people to reach the final location were there will be a prize. Though it is technically possible to implement an electronic on-line treasure hunt using mechanisms other than titles, a title enabled treasure hunt is significantly easier to implement due to the unique properties of a title. These properties include the ability to stop copies being made and the ability to control access.

The user signs up for the treasure hunt 310, and is given a title with the first task or clue 302. Depending on the embodiment the title itself will contain the clue or task description, or it will point to the task or clue. The user will then complete the task or clue and presents the title to the system to validate that the task or clue has been completed 303. In some embodiments the title will be needed to be presented before the task or clue can actually be completed. One example of this would that a user would go to a web site, and to another user without the title the web site would look as normal, however for users with the appropriate title, using the title pass mechanism the web site would reveal a hidden area.

The user will then receive the updated title, for example a title that now contains a new stub with updated information, that documents the proof of completion, with the new clue or task 304. Depending on the rules of the treasure hunt there maybe the ability to trade title with other users 305, this would be especially valid for embodiments of a treasure hunt where it may not be a simple step by step completion process, but rather there maybe multiple paths in order to complete the treasure hunt. The trading mechanism may use the mechanisms described in International Publication No. WO 03/098398 A2 incorporated herein by reference above, and address any issues with regards to copying of the title.

In one embodiment, upon completion of one step, participants in a treasure hunt are given a new title stub which allows them to progress to the next step in the game. The title(s) which facilitate the game can contain many stubs with each stub providing proof of completion as well as updates to the rights expressed by the title, thereby offering new actions to the user. A further embodiment of the treasure hunt would be that the user would not just have one title, but a collection of titles in order to add complexity and variety to the treasure hunt. If the user has not completed the treasure hunt then the process is repeated 308, if the user has completed then the user enters the prize award phase 309.

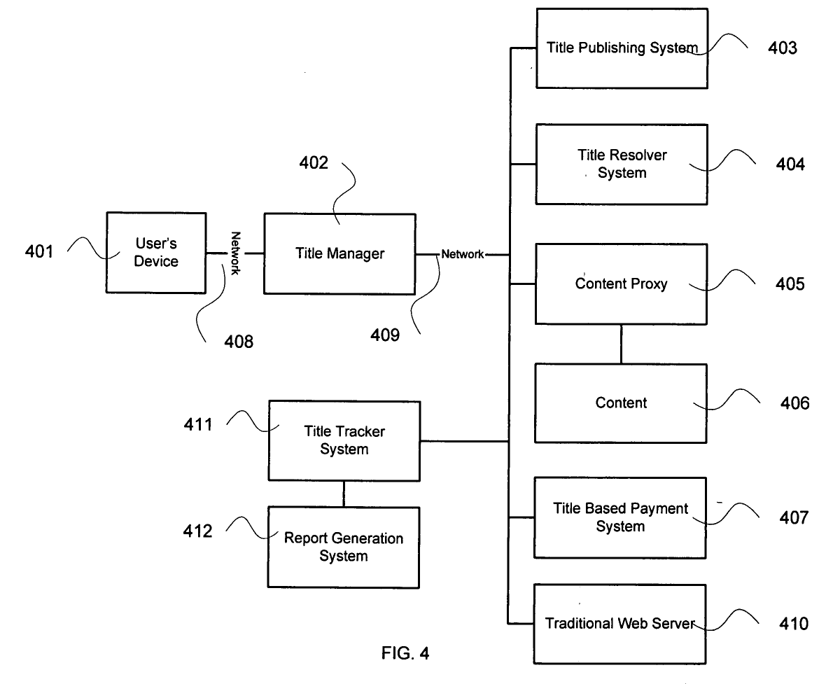

Referring now to FIG. 4, a simplified web content payment and services title transaction system with title tracking is shown, according to one embodiment of the invention. In a non-obvious manner, the properties of the title system can be used to track usage of the title to generate information, such as usage profiles of individual users and groups. The information and reports that can be generated from these transaction records is extremely rich and varied and examples of these reports include most popular content, usage of a particular service, time spent in a particular web site, usage patterns by demographics, and advertising follow through. It should be noted that the abilities of the tracking and reporting system may be limited by legal, contractual, or other limits depending upon the jurisdiction, the type of services and content, and the users involved. In describing this embodiment of the invention these restrictions will not be taken account of.

A component of the title system is the transaction tracker 411. The transaction tracker is a module that can track all aspects of title processing. As the transaction tracker “sees” titles being processed during the course of a transaction it can invoke system rights embedded within the titles to activate additional tracking logic, e.g., generation of specific reports. The publisher or issuer of a title can put tracking rights in the titles they publish which can be picked up by the tracker, thus allowing remote monitoring and notification. Such implementations involve the processing of titles which include rights, some of which are system rights which enable the tracking function.

User's device 401 (i.e., PC, cell phone, PDA, etc.) is coupled over a network 408 to title manager 402, an application which manages the user's titles. For example, title manager 402 would allow the user to organize, delete, add, transfer, trade, copy, back up, view, and redeem a title.

Title publishing system 403 contains a title to a content element 406, such as a music video. Title resolver system 404 resolves the selected titles, such as verifying integrity of the title, validating the title, ensuring ownership of the title, decoding and decrypting the necessary title elements and retrieving the content or resource requested. Requests to redeem content 106 are normally resolved through content proxy 405, which is aware of the actual network location of content. Title based payment system 407 provides a payment infrastructure, such as authorizing a payment provider to pay the content owner for any content that is redeemed. Traditional web server 410 may be a web site, such as Amazon.com, in which content 406 may be offered for sale or license.

Although the diagram shows separate components that maybe operated on separate computing devices, these components can be operated on the same device. For example, the functionality of title manager 402 can be operated directly on the user's device 401 as a complete application. Likewise the functionality of the title resolver system 404 may exist on the title publishing system 403. Also the term network refers to any mechanism that allows the transfer of data between computing devices.

The title tracker system 411 interacts with all the components of the system that process titles. In this embodiment it would be the title publishing system 403, title resolver system 404, title based payment system 407, and the title manager 402, in other embodiments it could be other title enabled systems, for example the title helper, the market maker, or the title search engine. In other embodiments of the invention the title tracker system may not be a centralized solution, but an additional functionality of the individual title processing component, or it maybe a combination of both a centralized and distributed system. The title tracker system is responsible for tracking and recording the events that occur on the title. These events could include publishing a title, redeeming a title, sharing a title, or storing a title in the title manager. The transactions and the information that is recorded are dependent upon the implementation and requirements of the system.

In another embodiment, the title tracker system can monitor the processing of all titles and execute tracking and monitoring rules as expressed by the titles. In this example, the tracker can invoke certain tracking rights (redemption methods) in the title as the title is processed or communicated. This allows the issuer of the title to provide additional monitoring over the use of the titles they have issued. As a further embodiment, the rules processing can be executed as a background task or even as an asynchronous task on a separated and connected system, without impeding the processing of the title.

The report generation system 412 is responsible for taking the collected transactions and processing that information to generate the reports. The mechanism for generating these reports will be dependent on the actual implementation, but they could be a function of the database that stores the transaction records, a report generation tool, or as a function of the title system itself.

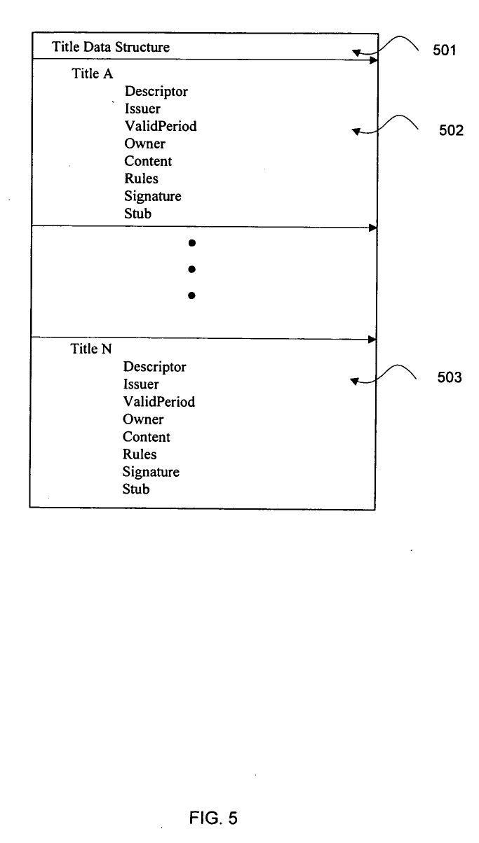

Referring now to FIG. 5, a simplified title data structure is shown, according to one embodiment. The title tracking system will record any information that is stored in the titles that are processed by the title system. Depending upon the configuration of the title tracking system, the information for title A 502, may be recorded in it's entirety in a distinct data record, or part of the information in a distinct record, in other embodiments the recording method for the title tracking system may process the tracking information directly, and update a summary record.

In another embodiment, the title tracking system may use information within a title, to cross reference other information held within the title system. For example when a title is purchased, it could be cross referenced to information that is held within the system, such that purchases of items could be cross matched to demographic information.

In yet another embodiment, the title tracking system, the information that is available from a particular user's title account can be used to reflect the information that is presented to the user. Of course privacy concerns may have to be addressed in such an embodiment and mechanisms could be provided to protect privacy. These mechanisms could be simple policy based systems such as opt in/out policies, or the user could have a marketing profile title. The marketing profile title would be a title that allows the user to see and control the information that is sent to third parties.

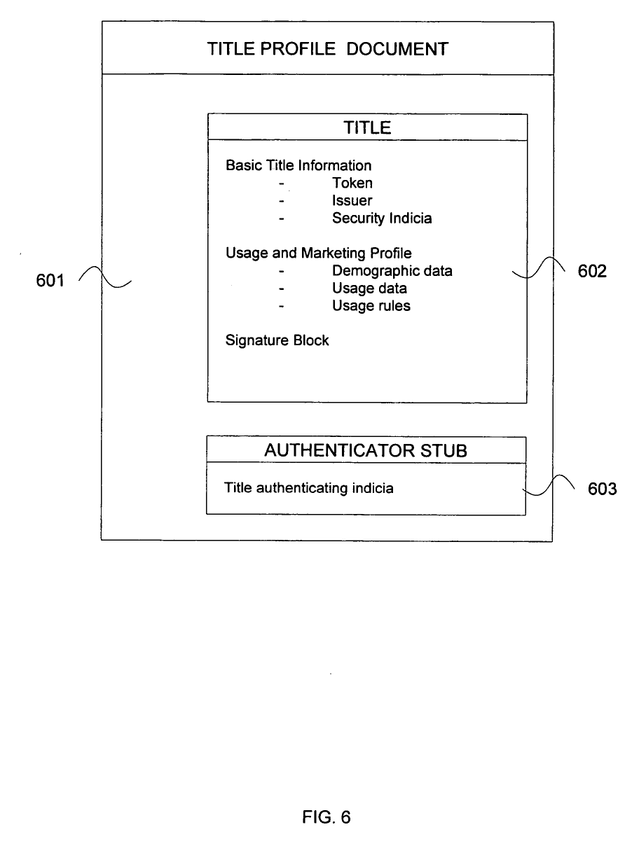

Referring now to FIG. 6, a simplified marketing information title document is shown, according to one embodiment. Title document 601 contains information about user 602, that the user wishes to be presented (i.e., demographic data, user usage, etc.). The user can also impose the rules on how this data is used and stored. The signature block 0603 is to ensure authenticity.

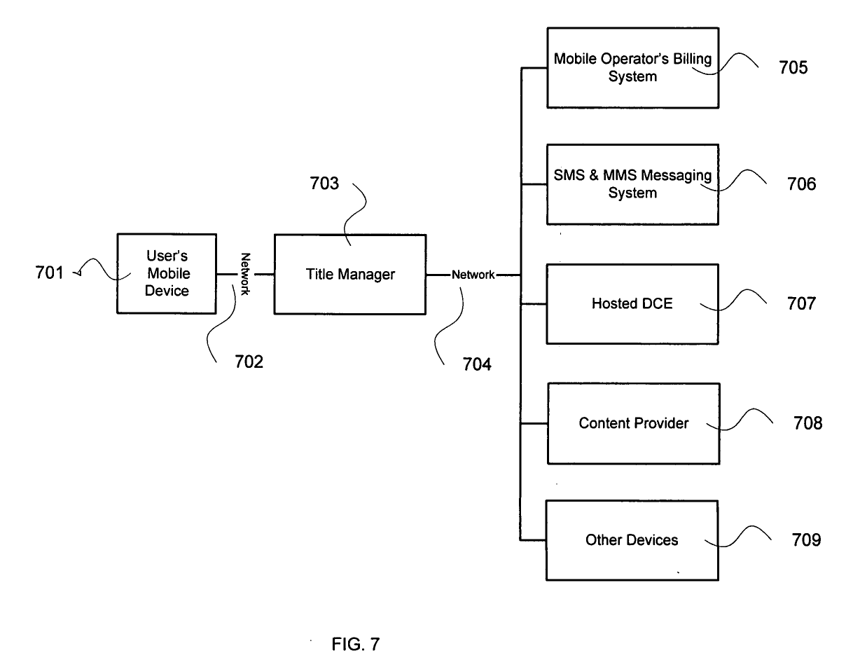

Referring now to FIG. 7, an example of a wireless locker system is shown, according to one embodiment. With today's mobile and wireless devices consumers are not just using these devices for simple voice and text communications but are taking advantage of all the new features that these devices offer. For example, these devices now have the ability to download games, polyphonic or MP3 ring tones, and exchange audio and video clips. These items will have value to the consumer either from the perspective of personal value, or that the consumer will have paid for them. From the consumer's perspective they have these items of value, and yet they have no where to store them other than on the mobile device. Normally the mobile devices will not support download to another device such as a PC in order to protect the content, and the will not allow copying to other devices for the same reason.

However this limitation presents a challenge for the consumer as the mobile device will have limited memory, which for example means that if the consumer purchases a new game, they will have to delete an old game for which they have paid, and yet they will now lose. Another challenge for the consumer is if they want to move to a new mobile device it is not possible to transfer the content that they have already purchased to the new device. The wireless locker is a system that overcomes the limitations described above while protecting the rights of the content owner. The wireless locker can also provide mechanisms for sharing content while respecting the rights of the content owners.

The user's mobile device 701 communicates with over the wireless network 702, with the wireless locker 703. The wireless locker 703 depending on the implementation will contain a number of the title transaction system components including the title management system. The title based wireless locker communicates with other components over a network that can be wireless or wired based 704. The mobile operator's billing system 705 is responsible for recording the transactions of the mobile user. The SMS and MMS messaging system 706 are responsible for SMS and MMS transactions. The hosted DCE 707 is responsible for carrying out title based transactions. The content provider 708 is responsible for providing mobile content. The system will interaction with other consumer devices 709, be they mobile devices or other devices such as a personal computer. In other solutions the implementation may be different such that the messaging system 706 may be part of the wireless locker 703, or the wireless locker 703 may host the DCE 707.

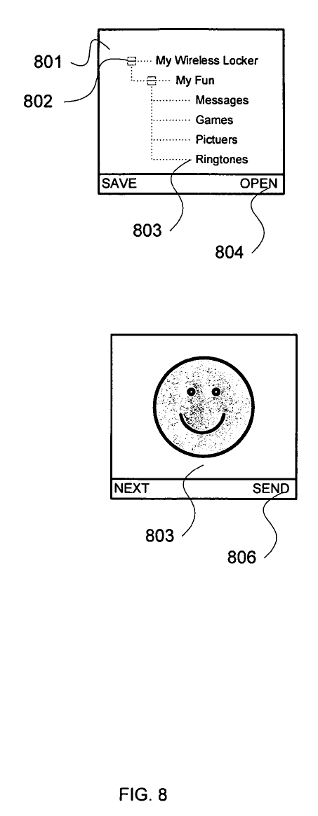

Referring now to FIG. 8, a simplified user interface to the wireless locker is shown, according to one embodiment. In one embodiment, the mobile browser technology is WAP. In another embodiment, the mobile browser technology is XHTML. The small screen of the mobile device means that only one window can be displayed at once 801. A list of the users content is shown 802, and individual content is shown 803, actions that can be selected from a menu 804. For some of the commands a new window will have to be displayed 805, with a new command menu 806.

Interaction with title-enabled systems can be problematic, particularly in a mobile environment, when a mobile device doesn't have the bandwidth, memory, processing power, or screen real estate to enable the type of synchronous interaction described elsewhere herein. Therefore, interaction with a title-enabled system, e.g., a title manager, is enabled via asynchronous messaging schemes. That is, instructions are sent from a device which is not title-enabled, e.g., a mobile device or a robotic device, to a title-enabled platform, e.g., a title manager, to conduct title-based transactions, using such messaging schemes.

According to specific embodiments, instructions to remote title-enabled systems and responses are sent in the form of SMS messages. For example, an SMS message may be sent to a particular code and include an instructions, e.g., to get particular content. In response to the SMS message, a title manager interprets the instruction and performs the specified action in the title-enabled realm, e.g., redeems specific rights on behalf of the user, and delivers the content or provides a link by which the content may be accessed. Other asynchronous mechanisms for providing instructions to the title manager include (but are not limited to), for example, email, MMS, instant messaging, SMTP, UDP, SOAP, etc.

It should be noted that while many of the examples described herein relate to the acquisition of digital content for personal and handheld computing devices, there are many other applications for interacting with a remote title-based system using asynchronous messaging schemes. For example, another class of title-based transaction which could be remotely controlled in this manner is in the realm of robotic control. That is, a robotic device in a manufacturing setting could use its own messaging protocol to send an instruction to a component of a title-enabled system instructing it to obtain a diagram for a model being constructed. It will be understood that the range of applications is virtually unlimited.

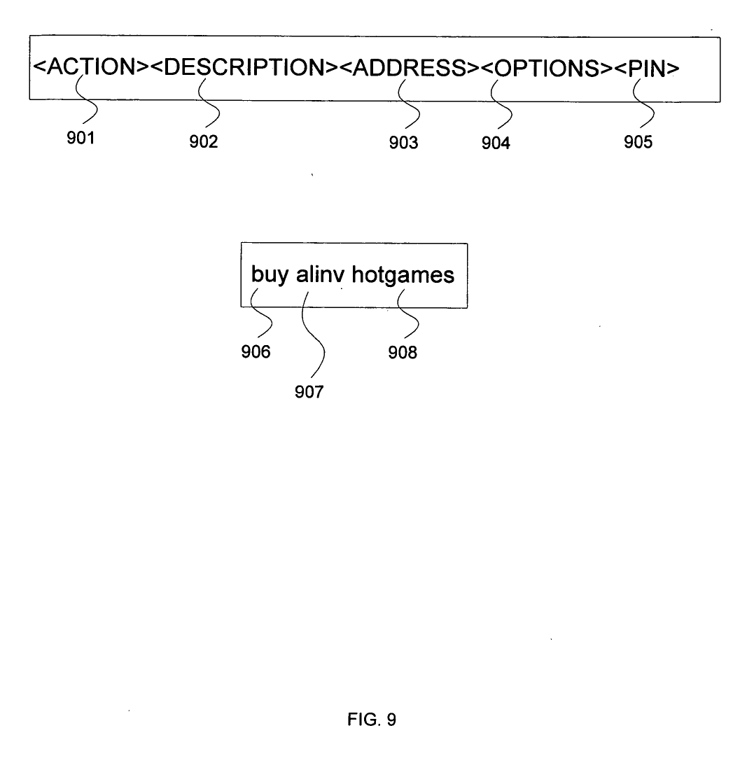

Referring now to FIG. 9, a simplified messaging based interface for a wireless locker is shown, according to one embodiment. As described above, a message based interface may be more desirable for some users as it requires less bandwidth, and works well within the widely used messaging systems. The actual format of the command will depend on the particular embodiment, but will generally follow a modification of the form described. The action describes the command that must be carried out 901, description describes the content or item that the action will be carried out on 902. The address is the address of the recipient or provider of the content 903. The options are modifiers of the command or provide extra information such as personal message 904. The PIN (personal identification number) provides a way of signing the message 905. An example command is shown in 99 that consists of the command buy 906, description of the content “alinv” 907, and the address of the content provide “hotgames” 908.

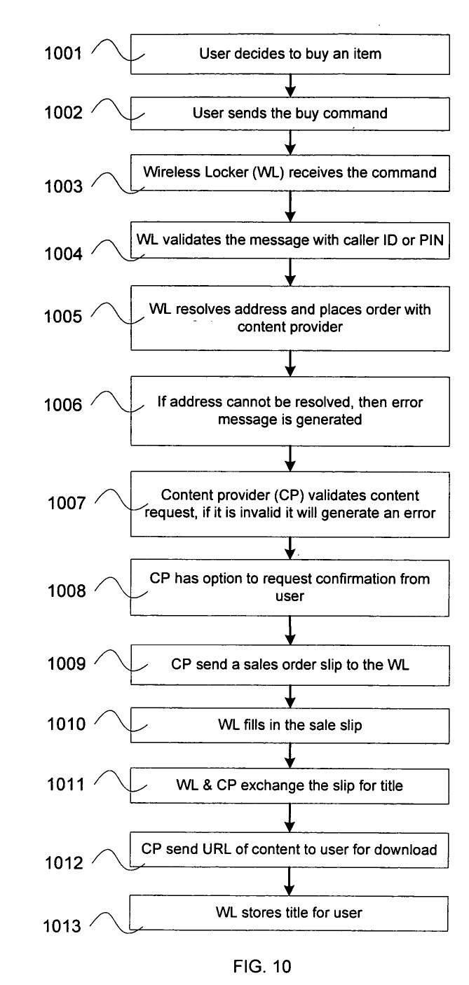

Referring now to FIG. 10, a simplified process for purchasing wireless content using a title enabled wireless locker is shown, according to one embodiment. The user decides to purchase an item 1001 (i.e., ring tones, screen images, premium alerts, games, etc.) and the user sends a the purchase message to predefined phone number for the wireless locker 1002. In another embodiment, the user would use a mobile browser interface to place the purchase.

The wireless locker receives the message 1003, and validates the sender of the message by using the caller ID which is sent over such mechanisms as SS7, or SS7 over IP 1004. Optionally the wireless locker can validate the sender of the message using a PIN that is sent within the message 1004. The wireless locker resolves the address within the message and places the order with the content provider 1005. If the address cannot be resolved then the wireless locker will generate an error message 1006. The content provider will validate the request for the content, and if the request is in invalid then an error message will be sent to the user 1007. The content provider then has the option to validate the purchase by sending a confirmation message to the user, which the user must reply to 1008.

The content provider will then send a sales order slip to the wireless locker based upon the payment mechanisms 1009. The wireless locker will then complete the sales order slip with an appropriate payment method 1009. This payment method could simply be a credit card, or other mechanisms using title enabled currency, or an account based basis could be used. The wireless locker then exchanges the completed sales order slip with a title to the content using such mechanisms as the digital lock box or other appropriate mechanisms for title exchange 1011. The content provider or the wireless locker depending on the embodiment have the option to send a message to the user with the URL to download the content or item to the mobile device 1012. The title is filed with the user's wireless locker account using appropriate criteria.

In another embodiment, the wireless locker may also store the content as well as the title, or the wireless locker may actually host the service for the content provider.

Once the user has a token or ticket to a piece of content then they have the ability to take advantage of the properties of titles. One of these properties is that it gives you rights to the content. Thus if the user has removed the content from their mobile device, or have moved to new mobile device then they can easily download that content based upon the rights expressed by the titles that they own.

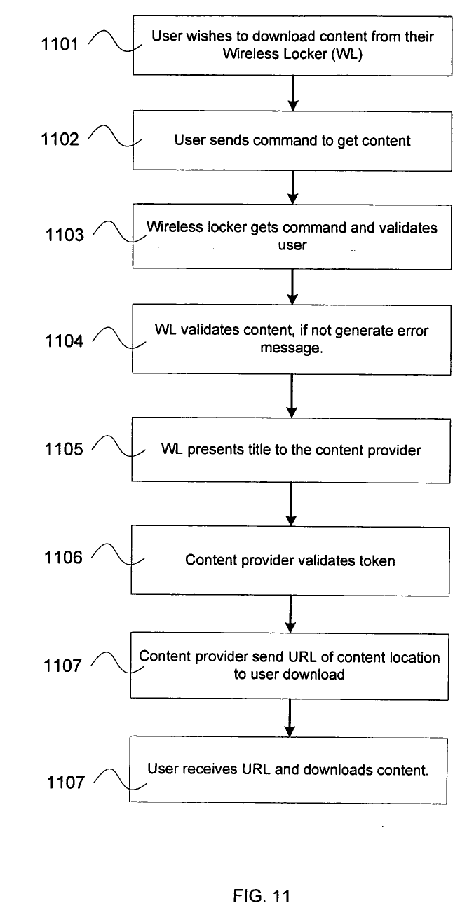

Referring now to FIG. 11, a simplified process for downloading content that the user has already purchased or has rights to is shown. The user wishes to re-download a piece of content form their wireless locker 1101. For a messaging based system the user will send a command to their wireless locker 1102, while in embodiments that use a mobile browser based interface the user would just select the content from the browser. The wireless locker receives the command and validates the use by mechanisms such as caller ID or PIN 1103. The wireless locker validates that the download request is valid, and if not it will generate an error message 1104. The wireless locker presents the title for the content to the content provider 1105. The content provider validates the title 1106 using the mechanisms described in International Publication No. WO 03/098398 A2 incorporated herein by reference above. The content provider then sends the user a message with an embedded URL that enables the user to download the content 1107. The user then downloads the content 1108. In other embodiments of the process the content may be held by the wireless locker, and downloaded from the wireless locker.

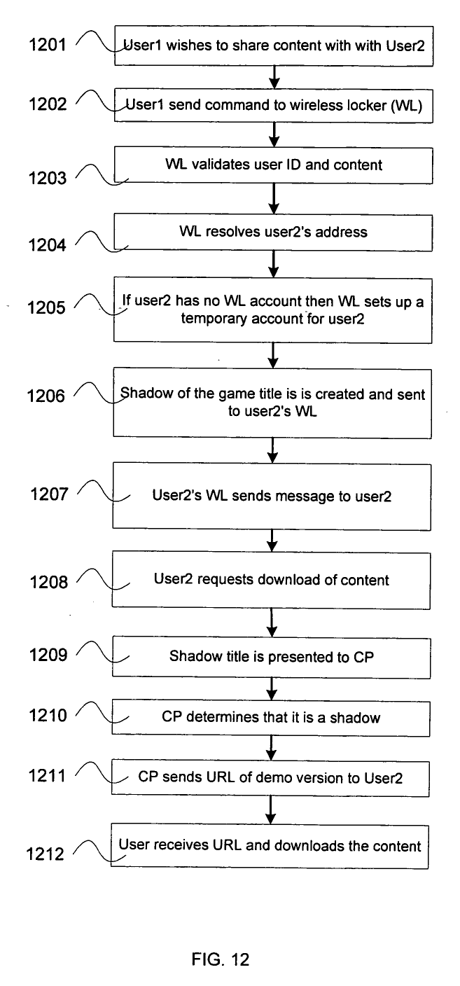

Referring now to FIG. 12, a simplified process of using titles to implement a wireless locker is shown, according to one embodiment. User1 wishes to share a piece of content with user2 1201, possible content types include games, premium MMS messages, or polyphonic ring tones. User1 sends the appropriate command to the WL using either a messaging based interface, or a mobile browser interface 1202. The wireless locker validates the request 1203, and resolves user2's address 1204. Possible embodiments of the addressing scheme include an email type addressing scheme, or the phone number of the recipient such as the MSISDN. Optionally user1 has the option of using the contact properties as described in International Publication No. WO 03/098398 A2 incorporated herein by reference above, and use an alias for the MSISDN or the email address.

If the wireless locker determines that user2 has no wireless locker account then it will create a temporary wireless locker account for user2 1205. The wireless locker then creates a shadow title of the title that represents the rights to the content that is being shared and is placed in user2's wireless locker 1206. User2's wireless locker sends a message to user2 stating that they have received a request to try out this content 1207. In other embodiments user2 may also receive a personalized message from user1. When user2 wishes to try out the content they will send a request to the wireless locker 1208. User2's wireless locker presents the shadow title to the content provider 1209. The content provider resolves the title and determines that it is a shadow title with no rights to the content 1210. The content provider sends a URL to user2 1211, who then downloads the content at their discretion 1212. In other embodiments of the process which use a mobile browser based system these steps could be hidden from the user, such that they receive a shadow title from another user and just click upon it to download the content.

In another embodiment, users may trade and transfer titles to content based upon the same mechanisms described for the wireless locker.

In another embodiment, a wireless locker does not have to be accessed just from the user's mobile device, but can also be accessed from other devices such as browser on a computer. This allows the user to manage and carry out tasks on the wireless locker using a user interface that may be more efficient for that task. Possible examples include entering contact details and entering credit card details.

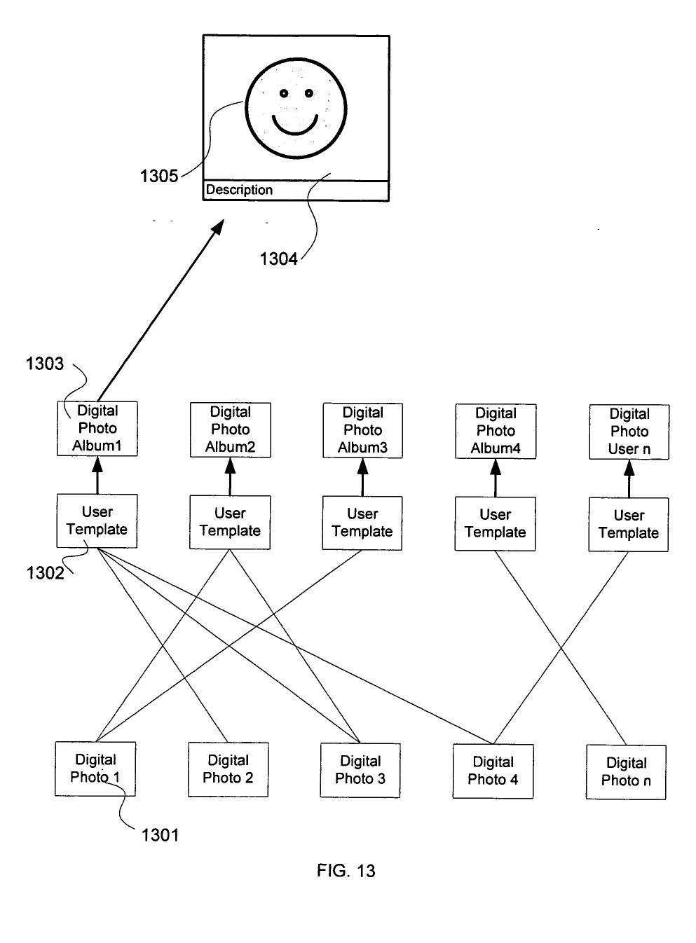

Referring now to FIG. 13, a simplified diagram of a wireless photo album is shown, according to one embodiment. A title based wireless photo album builds upon the properties of title (as described in International Publication No. WO 03/098398 A2 incorporated herein by reference above) allowing the user to use such features as contacts, and the ability to control who sees which particular photos. Using the property of titles that allows an abstraction layer between the content and the users such that it is possible to present a different subset of pictures to different users, this is shown at a high level in FIG. 13. The photos 1301 are stored in the MMS album, using templates 1302, the user can define which photos appear in an album 1303. The album of photos can be accessed with or without a title. The picture is displayed 1305, with an option synchronized presentation of text, audio, or graphics 1304, using such technologies as SMIL.

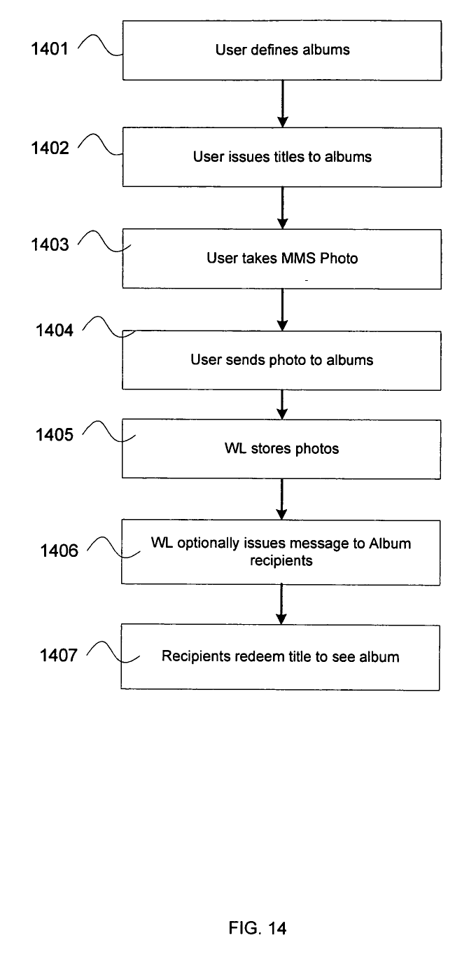

Referring now to FIG. 14, a simplified process of implementing a title based MMS photo album is shown, according to one embodiment. Initially the user defines the albums that they wish to share 1401. The user then issues each recipient a title that gives access to predefined albums 1402. Note that it is possible to define new albums and or issue new titles to the new albums or previously defined albums at any point in time. When the user takes an MMS picture 1403, the user defines the album that they want the picture to exist in. Either the albums can be addressed directly as an email/MMS type address, or the albums can be specified by means of a command line within the text body of the MMS message. The wireless locker will receive the MMS message and store the photo 1405. The wireless locker can optionally notify recipients who have access to the album, that there is a new picture available 1406. At any point in time recipients of titles to the albums can view the pictures within the album using their wireless device, personal computer, or any other connected device that is capable of accessing the content.

Note that in other embodiments of the wireless locker picture album the MMS content may not be a simple picture or photograph, but could be a synchronized multimedia presentation using such technologies as SMIL or MPEG-4 BIFS consisting of one or more of the following content types, possible content types include, photos, graphical pictures, SVG (scalable vector graphics) animation, audio, text, and MIDI type audio.

In another embodiment, the MMS protocol and standard is not used, but instead other equivalent mechanisms are used such that the functionality of the wireless locker picture album could be used, for example the picture sharing scheme that Sprint PCS uses.

In yet another embodiment of the wireless locker picture album would be for non wireless users who wish to share their pictures in the same way.

As described above, asynchronous messaging mechanisms, e.g., SMS, MMS, IM, or email, may be used to interact with and conduct transactions with a title-enabled system without instructing the title-enabled system directly, e.g., as is done with a title manager. According to some embodiments, the message may include a title (e.g., as an email attachment). According to other embodiments, the message may, itself, represent a title which may be stored remotely. The message may include, for example, a unique identifier of the title and a description or representation of one or more properties or characteristics of the title.

According to such an implementation, a title-enabled system could send such a message to a device which is not title-enabled, e.g., a cell phone or PDA, indicating that the recipient is entitled to $5 which can be redeemed at a particular online store. The message actually represents the title which the recipient may redeem at the site, either directly (i.e., using a title manager), or by sending a message to the title enabled system (e.g., forwarding the first message) to redeem the $5. If, in this example, the recipient of the $5 does not wish to open an account with the title-enabled store, the messaging mechanism of this embodiment may be used to provide change to the recipient at the end of a transaction in which the entire amount is not used. As will be understood, this mechanism may be employed to facilitate virtually any type of title-based transaction without the need for real time interaction with a title-enabled system.

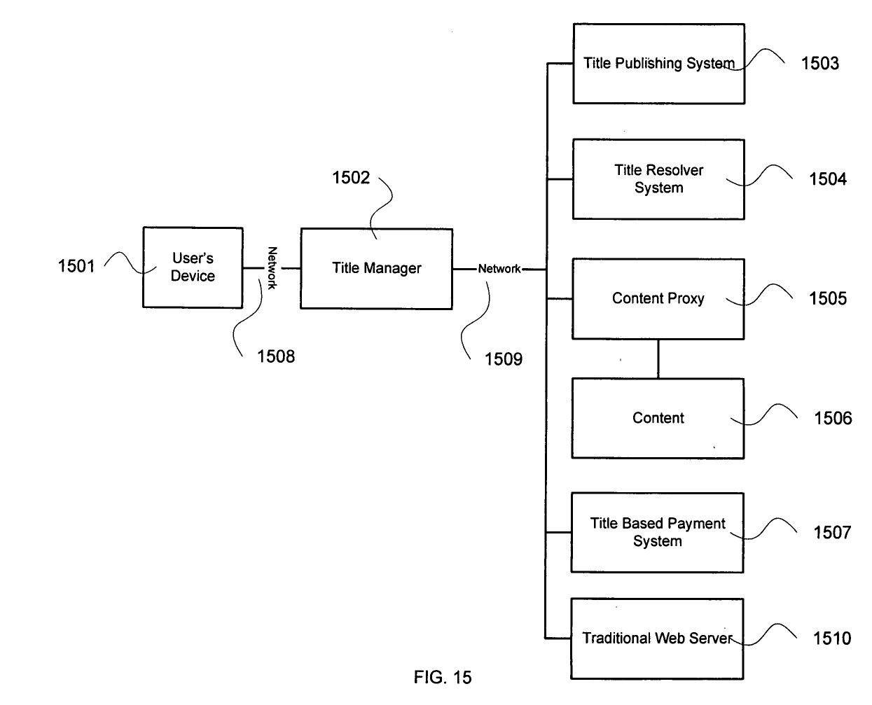

Referring now to FIG. 15, a simplified media transaction and distribution system is shown, according to one embodiment of the invention. Titles may be used to provide a system over which it is possible to develop a media transaction and distribution ecosystem. The media can be any electronic content that has value to the consumer and the transactions could be peer to peer, or business to business. The properties of titles and the title system that are advantageous to a media transaction and distribution systems include the payment system, the ability to share content while respecting rights, the content abstraction properties, links to physical items, the tracking and incentive marketing properties, and the trading properties. Example of the media types include music, video, still images, electronic trading cards, or title enabled passes to such services to online games.

User's device 1501 (i.e., PC, cell phone, PDA, etc.) is coupled over a network 1508 to title manager 1502, an application which manages the user's titles. For example, title manager 1502 would allow the user to organize, delete, add, transfer, trade, copy, back up, view, and redeem a title. Title publishing system 1503 contains a title to a content element 106, such as a music video. Title resolver system 1504 resolves the selected titles, such as verifying integrity of the title, validating the title, ensuring ownership of the title, decoding and decrypting the necessary title elements and retrieving the content or resource requested. Requests to redeem content 1506 are normally resolved through content proxy 1505, which is aware of the actual network location of content. Title based payment system 1507 provides a payment infrastructure, such as authorizing a payment provider to pay the content owner for any content that is redeemed. Traditional web server 1510 may be a web site, such as Amazon.com, in which content 1506 may be offered for sale or license.

Although the diagram shows separate components that maybe operated on separate computing devices, these components can be operated on the same device. For example, the functionality of title manager 1502 can be operated directly on the user's device 1501 as a complete application. Likewise the functionality of the title resolver system 1504 may exist on the title publishing system 1503. Also the term network refers to any mechanism that allows the transfer of data between computing devices.

The payment system for the media transaction system would bring the benefits of being able to offer payment from regular payment systems such as credit cards, bank accounts, or enable new payment schemes based upon digital cash equivalents or promotional points.

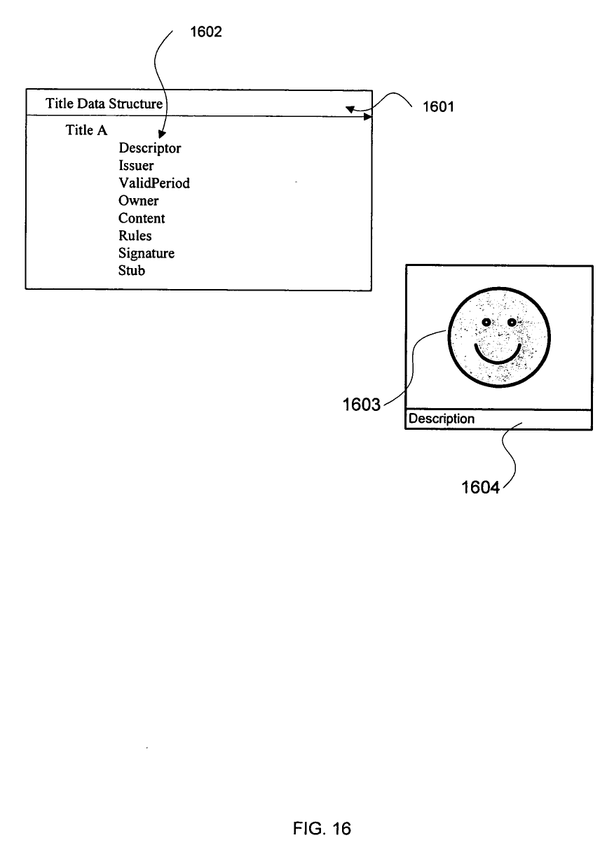

Referring now to FIG. 16, a simplified title data structure as may be used in a media distribution system is shown, according to one embodiment. Title structure 1601 contains a metadata description of the content 1602, that can contain multimedia types such as images 1603, along with a text description 1604. In other embodiments the description can contain other media types such as audio, scalable vector graphics or a synchronized SMIL presentation. The only limit is the size of the title which is dependent on the implementation of the title system. With this approach the multimedia content is not just described by simple text but also in ways that are more aesthetically pleasing or provide more relevant information to the consumer. This metadata description also allows the title to be easily searched upon.

Further the title does not have to point to a simple media type but can refer to a complex presentation of the content using such technologies as HTML, XML, MPEG-4 BIF's or SMIL. This approach would allow embodiments such as a virtual album cover, or a presentation of images with background audio.

Another key property of titles is that only one version of the title can be redeemed, as part of the redemption method ensures that any copies of that title is made invalid. Thus is a user has access to a piece of content with a title it is not possible for that user to share those rights with other users. However, as described in International Publication No. WO 03/098398 A2 incorporated herein by reference above, it is possible to create shadows of the title that can be shared with other users. When these shadows are presented, the content owner can present demo version of the content depending on the business rules that they wish to apply. The business rules may limit the content type or quality, or impose a time limit, or usage limit. This sharing concept can be extended further such that it is possible for a user who has access to content to allow other users to view that content only while the first user is accessing this content. This ability of titles and the title system to allow sharing only within the rules set by the content provider is key to some content providers in allowing their content to be electronically distributed.

The incentives and promotions properties of titles can be utilized to encourage this allowed sharing by generating promotional awards for users who share and inform other users of content that they may be interested in. The exact promotional awards scheme would be dependent on the business rules and models put in place by the content provider.

According to specific implementation, a digital flyer, e.g., a single page representation of a title-enabled offer, is used to initiate a transaction, e.g., the purchase of content. Such a flyer can be implemented, for example, as an HTML page, a Flash file attachment, or any other promotional presentation format (e.g., .pdf). The user receives the flyer as an attachment or views it on a P2P network, sees the promotion, and elects, e.g., by selecting a “buy” link, to initiate the transaction.

According to a more specific embodiment referred to as “Try/Buy/Earn,” a digital content file is encoded using any of a variety of DRM technologies and is then distributed, e.g., on a network or via physical means (CD, DVD, etc.). When the user opens the content file they are presented with a promotion and a licensing window. Within the promotional window the user is offered (via titles) the opportunity to view or play the content once (i.e., try), purchase the content (i.e., buy), or purchase the content and start to earn value for sharing and reselling (i.e., earn). Selecting the buy option allows the user to purchase a title that grants rights to the content. Invoking these rights will result in delivery of a proper DRM license. Selecting the earn option provides the user with a title that grants them the right to share or resell the content and expresses the reward that will be given when it is shared and purchased by other users.

The ability of titles to invalidate copies also allows new business models to be created. Embodiments of these new business models include the ability of a user to create a package of electronic content that can be given as gift, as described in International Publication No. WO 03/098398 A2 incorporated herein by reference above. A further embodiment is the concept of content resellers, that is the ability of third parties to purchase titles and package them together and resell that package of content.

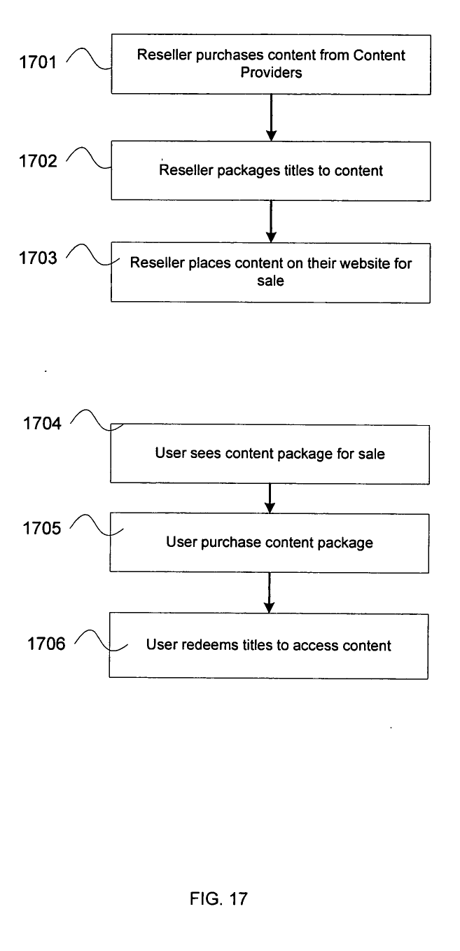

Referring now to FIG. 17, a simplified process of using titles to implement a reseller process is shown, according to one embodiment. The reseller purchases the titles to the content in bulk from multiple content providers 1701 using automated or manual methods. In other embodiments of the process the titles could be purchased on demand, or it could be a combination of these methods. In another embodiment of the process the reseller could purchase a title that gives the reseller the rights to generate a set number of titles that give rights to the content. The reseller then packages the multiple pieces of content titles 1702 and the reseller may add titles and content of their own. The mechanism for packaging the content titles can vary, but possible embodiments include HTML, XML, SMIL, or titles themselves. The reseller then places the package of content titles for sale 1703 using such mechanisms as a web page or other mechanisms. Users will find the package for sale 1704, and purchase the package of titles 1705 using the mechanisms described in International Publication No. WO 03/098398 A2 incorporated herein by reference above. The package is then transferred to the user's title manager. When the user accesses each piece of content 1706, each title will be redeemed with the original content provider. This ability to resell titles would allow resellers to create albums of music, photographs with their own added content.

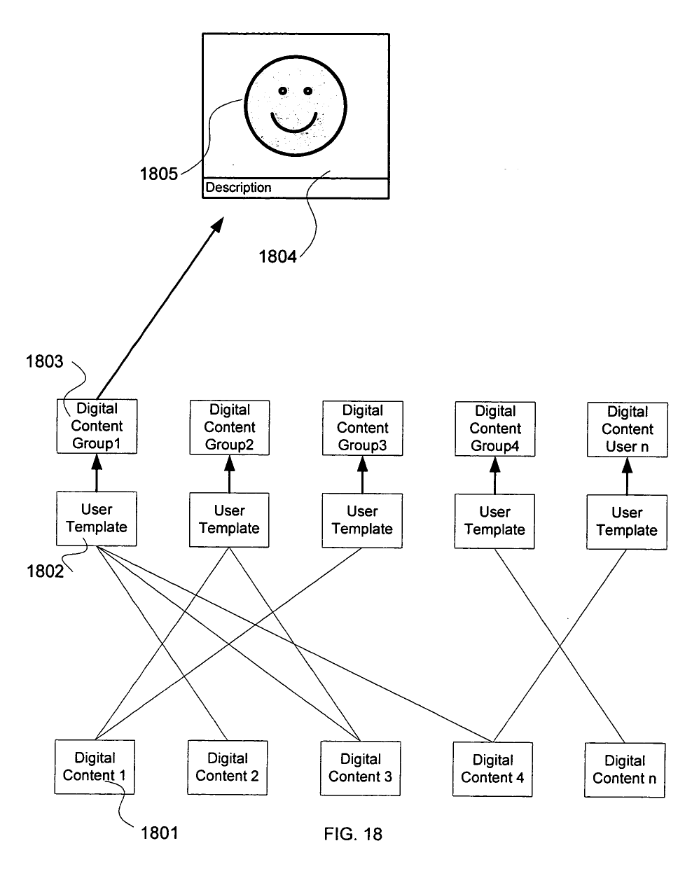

Referring now to FIG. 18, a simplified diagram illustrating an implementation in which titles are used to create a fan site, according to one embodiment. This approach would allow users to set up their own fan site that is a presentation of content from the content provider which the user personalizes. FIG. 18 shows one possible embodiment of the fan site concept were the content provider provides content 1801 that the use can select via means of a template 1802. This digital content group 1803 can be accessible by anyone, or a title based scheme can be used to control access. The resultant content is presented 1804 using such technologies as HTML or XML. The content 1805 can be any content type that can be displayed on the user's device. Optionally the user can embellish the content with their own generated content such as Blogs, text, or images.

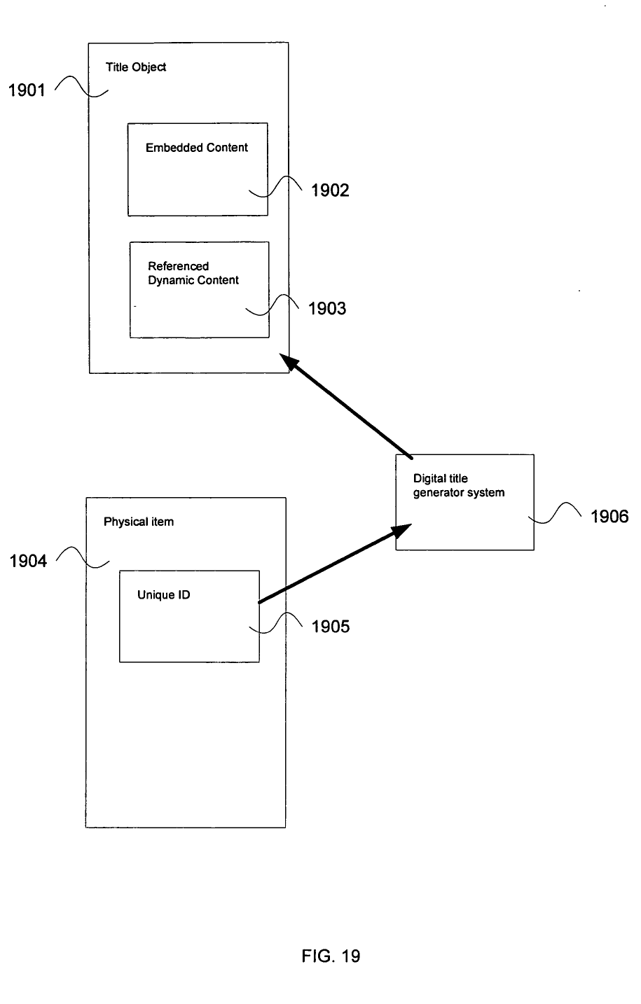

Referring now to FIG. 19, a simplified diagram in which a title is mapped to a physical item is shown, according to one embodiment. A user can purchase the a physical card, or other embodiments may include competition cards, including a physical item with another item such as a DVD or CD. As shown in FIG. 19 the physical item 1904 contains a unique ID 1905, that the user enters into the digital title generator system 1905 which for example in one embodiment could be a web page, in another it may be a messaging system that the user would send a message to. The digital title generator will create a title 1901 for the user, which can contain embedded content 1902, or refer to dynamic content 1903.

Another key feature that titles bring, is the ability to trade the media or content with other parties. It may be possible for users to establish the terms trade by any appropriate communication means, and then for the trade to be carried out through the Title system. This method can be enhanced by establish an automatic trading system were the rules for the trade can be established electronically and the trade can be carried out automatically.

In another embodiment titles could be used by small and medium sized business to enable then to easily control who can access their digital services and content, and to provide payment methods for these content and services. Furthermore other properties and embodiments of titles could be used such as the contacts properties of titles, the calendar properties of titles and the content abstraction layer. Though these features could be or have been implemented by other mechanisms, a title based approach provides a system that is easier to implement and use from perspective of both the customer and the small and medium business (SMB) owner.

Examples of the type of SMB's that would use a title enabled system are as follows: Any company that is electronic content such as documents, graphics, music, video clips or computer programs and source code with customers could use a title enabled SMB system. Other examples of SMB's that could use a title enabled system would be SMB's that are providing information services to their customers. Examples of such companies would be companies providing financial advice and companies providing market information and data.

The first property of a title that could be used by a SMB is the title pass property as allowing only paying customers to access pages on their websites. Optionally SMB's could provide a preview version of the service allowing customers to share their title pass with other people to enable them to try the services or content offered by an SMB. Further using the properties of title it would be possible for customers of the SMB service to invite guests while they are accessing the service.

Another property of the title system that would be of value to an SMB would be content presentation abstraction layer (as described in International Publication No. WO 03/098398 A2 incorporated herein by reference above), which would easily allow SMB's to present customized content such as research information or marketing information to specific individuals or groups of customers. Furthermore the content abstraction layer properties of titles allows SMB's to easily offer a personalized startup page. The abstraction layer can also be used by SMB's to offer customers the ability to create a personal portfolio. For example a real estate agent could offer this service to clients such that it would be possible for one customer to come up with a list of houses that they have found, save it and the customer's partner could access that list later.

As well as been able to share content and services between the SMB and customers it is also possible to share title enabled contact and calendar information between the SMB and their customers (as described in International Publication No. WO 03/098398 A2 incorporated herein by reference above). For example using a title enabled calendar it would be possible to schedule meetings between the SMB and their customers while not revealing sensitive information between the two parties.

The title enabled contact proxy allows SMB's to deliver time sensitive information to their customers by the most appropriate mechanisms for that customer. Further the SMB can use contact proxies to ensure that the customer is directed to the most appropriate person within the SMB. A further property that could be used by SMB are the payment or incentive properties of titles.

The invention is described with reference to specific apparatus and embodiments. Those skilled in the art may recognize that the description is for illustration and to provide the best mode of practicing the invention. For example, references are made to computer servers and clients, but in a peer-to-peer network, any computer is capable of acting in either role. Likewise, reference is made to Internet protocol while any substantially comparable data transmission protocol can be used.

Another embodiment of a Title system involves the usage of Titles for an electronic voting system. Given that the properties of Titles include the ability to represent rights, and the ability to not be reused or copied if the Title is redeemed. Based upon these properties using Titles to represent the rights to vote, and to allow users to vote, ensures a voting system that has the necessary security while providing a system that does not impose an excessive burden.

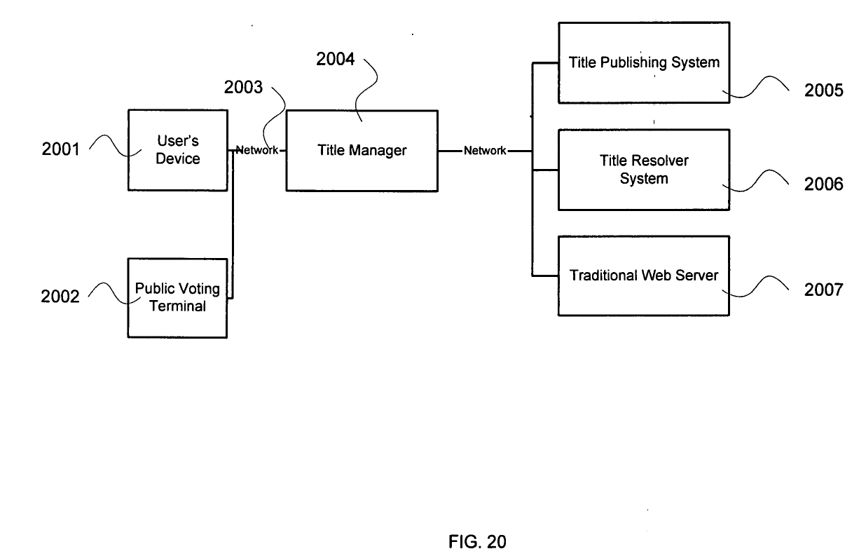

FIG. 20 shows a simplified embodiment of a title-based voting system. The users device 2001 is can be a personal computer, mobile device, or any other electronically connect device. The public voting terminal is a device 2002 that would be used at such locations as a voting station, or any other public place for voting. The voting terminal can be any electronic device that can be networked. Depending on the embodiment of the voting process both a user's device and the public voting terminal can be used to cast the vote, or only one or the other can be used to cast a vote. The network 2003 can be any wired or wireless network over which electronic communications can occur. The title manager 2004, is the system that holds the titles that gives the rights to the user to cast a vote. Depending on the embodiment of the voting process the title manager may be dedicated for the voting system, or can be a title manager that is normally used by the user, or a combination of the both. The title publishing system 2005 is responsible for publishing the titles that enable users to vote. The title resolver system 2006 is responsible for validating the titles, and the web server 2007 is responsible for carrying out traditional web functionality.

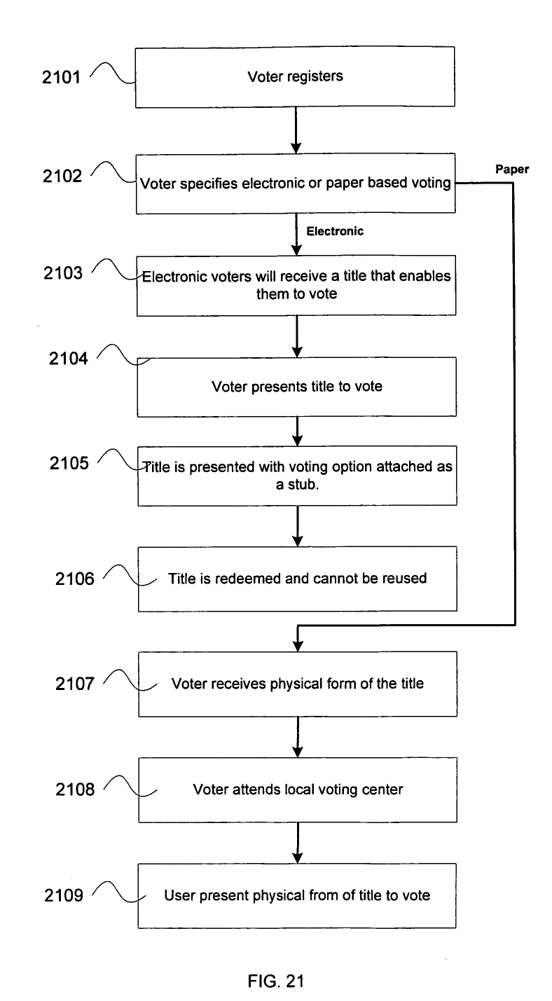

FIG. 21 shows one possible embodiment of a title-enabled voting process. The voter registers to vote 2101 which can be done electronically or via paper based mechanisms. Suitable mechanism will be used to establish the validity of the user to vote. The user specifies whether they wish to vote to using their own device, or through a public voting terminal 2102.

Users who are going to vote on their own device will receive a title that gives them the rights to place the vote 2103. That title maybe sent to the user's normal title manager, or the title may exist on a dedicated title manager for the voting system. Optionally the Title may have to be endorsed or made valid by some other piece of information such as an access number that has been sent through the mail, or another identifier of the person such as a digital certificate. When the user wishes to vote the user will use their device to access the voting system this could be done by presenting the title which will take the user to the voting system, or by other means such as a pre defined URL. The user then presents the Title in order to place the vote 2104. Depending on the implementation the Title may only be used to access the online system, which would be very appropriate when the voting has to be anonymous. In other situations the Title may be used to record the vote and then it is presented to the title enabled voting system by means of a stub that is attached to the Title 2105. The title is redeemed and the vote is placed 2106, as part of the Title redemption process the Title will be made invalid and cannot be used to place a vote again. Depending on the voting system it may be that there are a large number of items that the voter has to vote on. In this situation it would be possible to vote at separate times. The process for this would be that a stub would be attached to the title to indicate that a vote has been placed on that item, and the title is returned to the voter so that they can place a vote on the other items later.

For voters who use the public voting terminal they will receive a physical form of the title 2107. This physical form of the title could be an identifying number, barcode, magnetic strip, or an RFID (radio frequency identifying device). The voter attends the voting station 2108, and uses the paper form of the title to logon onto the voting terminal. The user then places their vote and the title is redeemed 2109 to place the vote and to make the title invalid to ensure that a vote cannot be place again.

In further embodiments of the title enable voting system technologies such as text to voice translation could be used to make the voting terminals usable by visually impaired voters. Other embodiments could include the ability to translate the voting system into other languages.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for interacting with a title-enabled system which is operable to conduct transactions using title objects, each title object comprising a unique instance of a digital bearer instrument representing at least one right which may be redeemed by presentation of the title object, the method comprising:
receiving an asynchronous message from a first device with the title-enabled system, the asynchronous message instructing the title-enabled system to conduct a first transaction involving transfer of at least one of title objects, the first device not being configured to conduct the first transaction;
interpreting the asynchronous message; and
conducting the first transaction on behalf of the first device.

2. The method of claim 1 wherein the asynchronous message comprises one of an email message, and SMS message, an MMS message, an instant messaging message, an SMTP message, a UDP message, and a SOAP message.

3. The method of claim 1 wherein the asynchronous message comprises a representation of the at least one of the title objects involved in the first transaction.

4. The method of claim 1 wherein the first device comprises a wireless device having limited storage capabilities, the method further comprising storing at least one other of the title objects on behalf of the first device in a wireless locker associated with the title-enabled system for subsequent access by the first device.

5. A computer-implemented method for guaranteed delivery of digital content using title objects, each title object comprising a unique instance of a digital bearer instrument representing at least one right which may be redeemed by presentation of the title object, the method comprising:
transmitting a first title object to a recipient in response to selection of the digital content and the recipient by a sender, the first title object defining a proof-of-delivery mechanism;
in response to presentation of the first title object by the recipient, facilitating completion of the proof-of-delivery mechanism by the recipient; and
facilitating access to the digital content by the recipient in response to completion of the proof-of-delivery mechanism.

6. A computer-implemented method for delivery of digital content using title objects, each title object comprising a unique instance of a digital bearer instrument representing at least one right which may be redeemed by presentation of the title object, the method comprising:
transmitting a first title object to a recipient, the first title object representing a right to receive the digital content upon completion of a specified action;
in response to presentation of the first title object by the recipient, facilitating completion of the specified action by the recipient;
transmitting a second title object to the recipient in response to completion of the specified action, the second title object representing a right to access the digital content; and
facilitating access to the digital content by the recipient in response to presentation of the second title object.

7. A computer-implemented method for facilitating interaction with a game which includes a plurality of sequential steps using title objects, each title object comprising a unique instance of a digital bearer instrument representing at least one right which may be redeemed by presentation of the title object, the method comprising:
transmitting a first title object to a player, the first title object representing a right to participate in a first step of the game;
facilitating participation of the player in the first step of the game in response to presentation of the first title object;
transmitting a second title object to the player in response to completion of the first step of the game, the second title object representing a right to participate in a second step of the game; and
facilitating participation of the player in the second step of the game in response to presentation of the second title object.

8. A computer-implemented method for facilitating voting using title objects, each title object comprising a unique instance of a digital bearer instrument representing at least one right which may be redeemed by presentation of the title object, the method comprising:
providing a first title object to a voter, the first title object representing a right of the voter to cast a vote; and
facilitating casting of the vote by the voter in response to presentation of the first title object.

9. The method of claim 8 wherein the first title object represents rights of the voter to cast a plurality of different votes, the method further comprising altering the first title object to reflect casting of each of the votes by the voter.

10. A computer-implemented method for tracking a transaction involving title objects, each title object comprising a unique instance of a digital bearer instrument representing at least one right which may be redeemed by presentation of the title object, the method comprising:
facilitating the transaction with a title-enabled system by facilitating transfer of the title objects between entities involved in the transaction, selected ones of the title objects representing rights of the title-enabled system to capture tracking information for corresponding aspects of the transaction; and
in conjunction with facilitating transfer of each of the selected title objects, invoking the rights to capture the tracking information.

11. A computer-implemented method for providing access to digital content using title objects, each title object comprising a unique instance of a digital bearer instrument representing at least one right which may be redeemed by presentation of the title object, the method comprising:
transmitting a digital content file to a user;
in response to selection of the digital content file by the user, presenting a try option, a buy option, and an earn option to the user, the try option enabling the user to preview at least a portion of the digital content file, the buy option enabling the user to purchase the digital content file, and the earn option enabling the user to purchase the digital content file and earn value for providing the digital content file to other users; and
in response to selection of one of the try, buy, and earn options by the user, facilitating the selected option using the title objects.
